(19) United States
(12) Patent Application Publication
(10) Pub. No.: US 2020/0202343 A1
(43) Pub. Date: Jun. 25, 2020

(54) BLOCKCHAIN-BASED SUSPICIOUS ACTIVITY VERIFICATION AND RECORDING

(71) Applicant: PAYPAL, INC., San Jose, CA (US)

(72) Inventors: Meng Shi, San Jose, CA (US); Udeep Manchanda, Pleasanton, CA (US); Bailiang Gong, Milpitas, CA (US); Yongmei Xue, Cupertino, CA (US)

(21) Appl. No.: 16/227,052

(22) Filed: Dec. 20, 2018

(51) Int. Cl. G06Q 20/38; G06Q 20/40; G06F 16/182; H04L 9/06; H04L 9/32

(52) U.S. Cl. CPC G06Q 20/389; G06Q 20/3827; G06Q 20/401; H04L 2209/56; H04L 9/0643; H04L 9/3297; H04L 2209/38; G06F 16/1824

(57) ABSTRACT

This disclosure describes particular use of a blockchain based method that allows for sharing of verification information from heterogenous sources, including multiple participants in an electronic transaction. In some instances a method includes generating a sub chain branching from a blockchain main chain in response to comparing the details of a transaction against a set of criteria, including generating a first block identifying the transaction and a sender or receiver for the transaction; notifying one or more parties to the transaction that the sub chain is created; determining that a threshold number of the one or more parties have verified a characteristic of the transaction; and merging the sub chain into the main chain based on the party verifying the characteristic.

### BACKGROUND

### Field of the Invention

The present disclosure generally relates to blockchains and, more specifically, to using blockchain techniques to verify and record suspicious activity.

### Related Art

Analysis algorithms can be used to determine whether a particular electronic activity poses a security risk. Thus, when a user attempts to perform one or more specific actions via an electronic platform, characteristics of these actions may be analyzed to determine whether the action should be allowed or disallowed by the electronic platform. For example, certain types of activities may indicate that a particular user account has been compromised (e.g. via a computer security exploit); such activities may be prohibited or subjected to heightened security mechanisms if an analysis algorithm indicates the need.

A present issue, however, is that in many cases, organizations do not share data across their platforms for the purposes of assessing operational risk. A first provider system that allows certain functionality from its computer platform thus might not be aware of other actions taken via a different provider system. Applicants recognize that the inability to access such data in a reliable, secure, and trustworthy fashion is a problem that compromises computer system security and operational integrity of online service providers.

The present disclosure includes technological solutions that provide techniques, in various embodiments, to detect suspicious activity and to record suspicious activity in a way that is safe and reliable, while reducing a noise level by reducing an amount of information sharing (including sharing information that may have reliability concerns). In particular, as discussed below, this may be enabled using particular technical data handling operations via a blockchain powered system (which may be implemented via a private or semi-private blockchain, in some instances).

### BRIEF DESCRIPTION OF THE FIGURES

FIG. 1 is block diagram of a networked system suitable for use with verifying and recording suspicious activity according to an embodiment.

FIG. 2 is an illustration of an example process performed by publishers and subscribers to the system, according to one embodiment.

FIG. 3 is an illustration of an example process for creating a sub chain and merging the sub chain into a main chain, according to one embodiment.

FIG. 4 is an illustration of example blocks that may be used in the sub chains or main chain of FIG. 3, according to one embodiment.

FIG. 5 is an illustration of an example method of detecting a suspicious transaction, according to one embodiment.

FIG. 6 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

When suspicious activities are detected in a payment network, mechanisms of sharing detection data between transaction participants may be inefficient and time-consuming. For instance, many transaction participants such as banks, credit card companies, payment service providers, and the like, may have their own risk analysis algorithms. However, when a given entity detects suspicious activity, there may be barriers to sharing that information. Such barriers may include disparate standards and nomenclatures in each of the different risk analysis algorithms and restrictions against sharing personal identifying information.

Exchanging suspicious activity data may be handled by centralized authorities, such as Financial Crimes Enforcement Network (FinCEN). However, compliance with FinCEN may involve an intensive amount of paperwork, which may create further delays compared to how fast a suspicious activity may spread and cause negative impacts. It is believed that some violations and transaction loss could have been avoided if the suspicious activity information was otherwise shared between financial institutions more quickly.

On the other hand, detection conducted by entities involved in a transaction sometimes can be inaccurate (either too many false positives or missing true-positives). Thus, casually sharing unverified data about suspicious activities between participants of a payment network can in some instances be unsafe, unreliable, or noisy as well.

Various embodiments provide for techniques to detect suspicious activity and to record that suspicious activity using blockchain technology (i.e. particular operations using a blockchain-based platform). Transaction participations such as financial institutions may be members of a network, where participants to a particular transaction may contribute to detecting suspicious activity within that transaction or related transactions, record the transaction in blocks of the blockchain, and collectively verify the suspicious activity before merging those blocks into a main chain of the blockchain. Note that in various instances, such a blockchain may be private (e.g. closed membership relying on approval of one or more entities to participate on the blockchain) or may be semi-private (e.g. some levels of functionality may be exposed to non-members, such as read access to certain data elements, but write access or other read accesses may be restricted). Note that even in a private blockchain based embodiment, certain members in the blockchain based platform may have different privilege levels and/or functional abilities, as further discussed herein.

In one example, a first financial institution, which is a member of the network, detects that a transaction may be suspicious using its own risk analysis algorithm. The first financial institution then looks to the blockchain to check whether the same sender and receiver have been reported for suspicious activity for the same transaction or a related transaction in an unverified sub chain. If so, the first financial institution may then add its own block to the existing sub chain. The first financial institution may also vote on the suspicious nature of the transaction by either verifying the suspicion or not verifying the suspicion. Note that as used herein, the term “suspicious activity” includes behavior that may be indicative of fraud, illegal activity, prohibited activity (e.g. by terms of use of a payment network and/or services platform), and/or a computer system security breach (such as an account and/or device whose authentication credentials have been compromised).

Continuing with the example, it may be the case that the sender and receiver pair have not been reported for suspicious activity for either the same transaction or a related transaction in any existing unverified sub chain. Accordingly, the first financial institution may create a first block in a sub chain as a branch from the main chain to identify the transaction, the parties to the transaction, and any other information that may help in determining whether the transaction is suspicious or possibly illicit. The first financial institution may then notify the counterparties to the transaction. For instance, if the first financial institution is a credit card company, then it may notify the issuing bank and the acquiring bank that it has detected potentially suspicious activity and created the new sub chain. Note for purposes of this disclosure, while various examples are given with respect to a financial institution, this may be any entity in various embodiments (that is, the operations herein are not limited to operations with financial institutions, although for ease of explanation certain operations, events and techniques may be described with respect to one or more financial institutions).

Further in this example, the counterparties to the transaction may receive that notification and check their own databases (e.g. databases outside of the blockchain platform) to verify the sender and receiver and to evaluate the suspiciousness level of the payment activities. Each of the different counterparties may add to the sub chain by reporting their findings and, if appropriate, verifying or disputing the suspicious nature of the transaction.

In the meantime, the same sender and receiver pair may be involved in additional transactions related to the first transaction. These additional transactions may be evaluated by their own counterparties, and those counterparties may also contribute to the sub chain. In fact, the additional transactions may implicate additional counterparties, thereby increasing the number of counterparties watching that particular sub chain. The additional counterparties may also verify or not verify the suspicious activity, thereby contributing to the vote. Therefore, as time goes on, a given unverified sub chain may grow as additional counterparties contribute and as the particular sender and receiver participate in additional transactions.

Further continuing with the example, some of the counterparties may view the transaction as suspicious according to their internal risk algorithms, whereas other counterparties may not view the transaction as suspicious. Counterparties that do not view the transaction as suspicious may record that determination in a block in the sub chain or not. In any event, whether a counterparty determines that the transaction appears to be suspicious (or not) the counterparty may decide to add the sender and receiver to its internal watchlist to provide scrutiny to that transaction or other transactions in the past or future. Furthermore, one or more counterparties may decline the transaction in response to the information it discovers in the sub chain. The present techniques may thus allow for secure sharing of information regarding transaction evaluation, without entities having to divulge details of their propriety risk evaluation algorithms (which most companies do not wish to necessarily make public).

Various embodiments allow for a threshold of verification before the sub chain is merged into the main chain of the blockchain. For instance, the system may have a threshold number of party verifications depending on any appropriate factor, including number of counterparties involved, suspiciousness rating of the transaction, length of the sub chain, and the like. As noted above, each of the counterparties may provide its own vote by verifying the suspicious nature of the transaction. Once that threshold is reached, the system may then create a verified block as a new head of the sub chain and then merge that sub chain into the main chain, thereby creating a new verified block in the main chain.

Of note in this example is that the suspicious nature of a transaction is notified to a subset of the members of the network before verification of the transaction, according to various embodiments. The subset of the members of the network may include in some instances only the counterparties to the transaction or transactions. Of course, various embodiments may extend the subset to include other members that may be interested but may not be counterparties to the transaction, such as members/entities who have engaged in transactions in the past with the sender or receiver to the transaction or may be engaged in the future, such as based on the same type or location of merchant involved in the current transaction. In any event, before the suspicious nature of the transaction is verified, only a subset of the members of the system may be notified. Also of note is that the counterparties to the transaction are each notified and given a chance to verify the suspicious nature of the transaction. Finally, as noted above, whether an activity associated with or corresponding to a transaction is suspicious may vary based on the entity or the transaction and can include any activity that is looked at by an entity in determining whether to approve, deny, or flag a transaction. Examples of such activities include, but are not limited to, initiating the transaction from or sending the transaction to a certain IP address, location, device, person, or entity, requesting a certain amount for the transaction, identifying a certain type of purchase for the transaction, initiating the transaction at a certain time or date, and requesting the transaction from a certain merchant or entity.

As noted above, notification for an unverified transaction may be limited to a subset of the membership of the network (e.g., the counterparties to the transaction). Such limited notification may create less noise in the network. This may be an advantage to members of the network who are not interested in that particular transaction, as those other members may be omitted from the notifications, thereby saving those other members from the trouble of acknowledging the notifications or otherwise participating in the verification.

Additionally, and as noted above, since members understand that creating a new sub chain may affect only a small number of other members in the network, the members may be motivated to err on the side of reporting suspicious activity and to seek verification. Furthermore, each of the verified suspicious activity blocks may be treated with some measure of authority because the members understand that the transaction would have had to have been verified by a threshold number of counterparties before being made part of the main blockchain. Thus, in various instances, sub-chains are kept out of the main blockchain (avoiding cluttering it) until and unless the activities on that sub-chain are verified by a threshold of participants (who may or may not have equal participation shares in reaching the threshold, e.g., one party might receive 20%, 80%, 150%, or some other number, of the participation share of some other participant, depending on specified rules, in various embodiments.

Another potential advantage is that reporting into the blockchain may satisfy government reporting requirements, thereby reducing an amount of paperwork or other reporting activities. Also, the notifications may be made electronically and in either real-time or near real-time, thereby increasing the speed at which the information is shared among the counterparties. This may be advantageous to the counterparties, as they may take actions such as declining a transaction, thereby reducing a number of violations and money loss due to the suspicious activity. Furthermore, members who may not be party to a given transaction may still be permitted to search the main chain and sub chains for patterns of suspicious activity, and use the information gained to update their internal risk analysis to take into account new suspicious activity patterns or to improve reaction to old suspicious activity patterns.

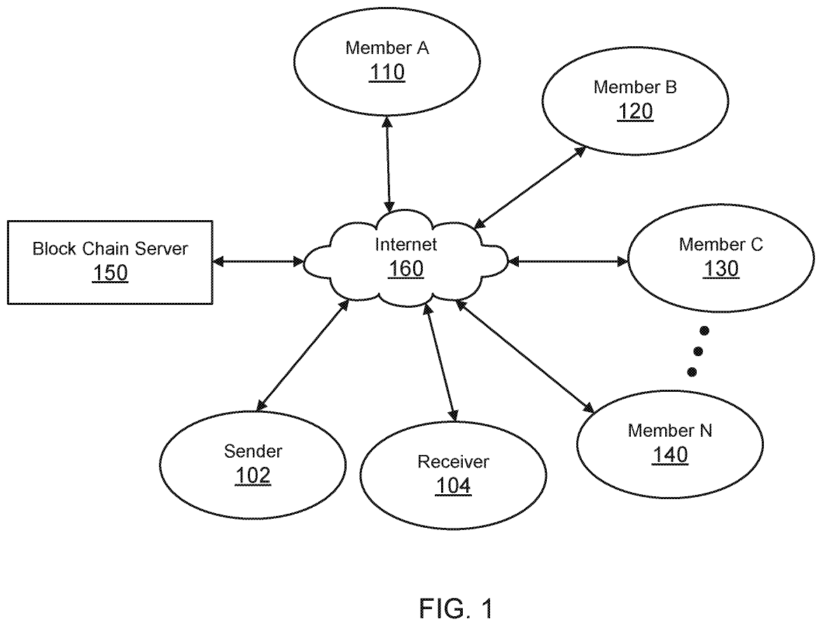

FIG. 1 is a block diagram of a networked system suitable for suspicious activity recording and reporting according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a multitude of servers 110-140 belonging to members A-N, where A-N can be any appropriate number. System 100 also includes blockchain server 150, and each of the different servers 110-150 are in communication with each other over a network 160.

Servers 110-150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

System 100 also includes sender device 102 and receiver device 104, which are associated with a sender and a receiver, respectively. In various embodiments, the sender is a party to a transaction, usually an end user who sends funds to a receiver. Similarly, the receiver may be a party to the same transaction, usually an end-user who receives funds from the sender. An example may include a customer as a sender and a merchant as a receiver, although the scope of embodiments is not so limited. For instance, various embodiments may include cash transfer transactions outside of any purchase for goods or services, so that the sender is the transferor and the receiver is the transferee. As explained in more detail below, the members A-N may be financial institutions who facilitate various transactions. Furthermore, various embodiments include the members A-N contributing to the detection and recording of suspicious activities using blockchain server 150, whereas the sender 102 and the receiver 104 would not be members and would not be privy to the communications among the members A-N and server 150.

Sender and receiver devices 102 and 104 may be implemented using any appropriate hardware and software configured for wired and/or wireless communication over network 160. For example, in one embodiment, each of devices 102, 104 may be implemented as a personal computer (PC), a smart watch, a smart phone, a smart phone with additional hardware such as NFC chips, BLE hardware etc., wearable devices with similar hardware configurations such as a gaming device, a virtual reality headset, or that talk to a smart phone with unique hardware configurations and running appropriate software, laptop computer, and/or other types of computing devices capable of transmitting and/or receiving data, such as an iPad™ from Apple™.

In one example, the sender device 102 is a user device, such as a smart phone, which has a payment application installed thereon. When the user of the sender device 102 desires to make a purchase or otherwise transfer funds, the user employs the payment application to transfer payment information. For instance, the sender may make purchases online, transfer money from an account or digital wallet to the receiver, or make purchases in a brick-and-mortar store by interacting with a point-of-sale device to transfer payment.

In another example, the receiver device 104 is associated with a merchant, so that the receiver device 104 may be a merchant server, and the merchant may have a physical point-of-sale (POS) store front and/or an online marketplace. The receiver device 104 may be used for POS and online purchases and transactions. Generally, receiver device 104 may be maintained by anyone or any entity that receives money, which includes charities as well as retailers and restaurants. For example, a transaction may be payment or gift to an individual. In yet another example, the receiver device 104 is simply a personal device of an individual who receives money from the sender. Examples of transactions include purchases of goods or services, refunds of purchases either in whole or in part, money transfers, donations, and information access where information may be exchanged in addition to money or in the absence of money.

An example of a member server 110-140, may be a server associated with a payment card service provider that is part of a payment network. One example includes a payment network operated by payment card service providers or card associations, such as DISCOVER, VISA, MASTERCARD, AMERICAN EXPRESS, RuPAY, China Union Pay, etc. The payment card service providers may provide services, standards, rules, and/or policies for issuing various payment cards. A network of communication devices, servers, and the like also may be established to relay payment related information among the different parties of a payment transaction.

Another example of a member server 110-140 may include a server associated with an issuer host. Such a server may be operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at various merchants who agreed to accept the payment card.

In another example a member server 110-140 may be a server associated with an acquirer host, such as a server operated by an acquiring bank. An acquiring bank may include a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

In various embodiments, one or more of the servers 110-140 may also be associated with a member who is a payment service provider. A payment service provider may have agreements with senders, receivers, issuing banks, and acquiring banks to further facilitate payment. An example of a payment service provider is PayPal, Inc, which provides applications to user devices, merchant devices, and financial institutions. Other examples of members may include insurance companies, brokers of property, and the like. Note that participation, however, is not limited to these examples.

Accordingly, when a sender sends funds to a receiver, there may be a transfer of funds from an issuing bank to an acquiring bank. Furthermore, the transaction may include interactions with a payment service provider, a payment card service provider, and/or other entities. In these examples, the issuing bank, the acquiring bank, the payment service provider, and the payment card service provider may be members of a suspicious activity detection network, as described in more detail below. For instance, any of the members who is involved in a transaction may analyze the transaction using their internal risk analysis algorithms and depending on the outcome of the risk analysis algorithms, may start a sub chain or add to a sub chain at blockchain server 150. The publishing member may then notify the other members who are counterparties or who are otherwise interested in the transaction. That subset of members may also determine to verify or not verify a suspicious nature of the transaction, and the publishing member may generate a verified block and merge the sub chain into the main chain at the blockchain server if a threshold of verification is achieved.

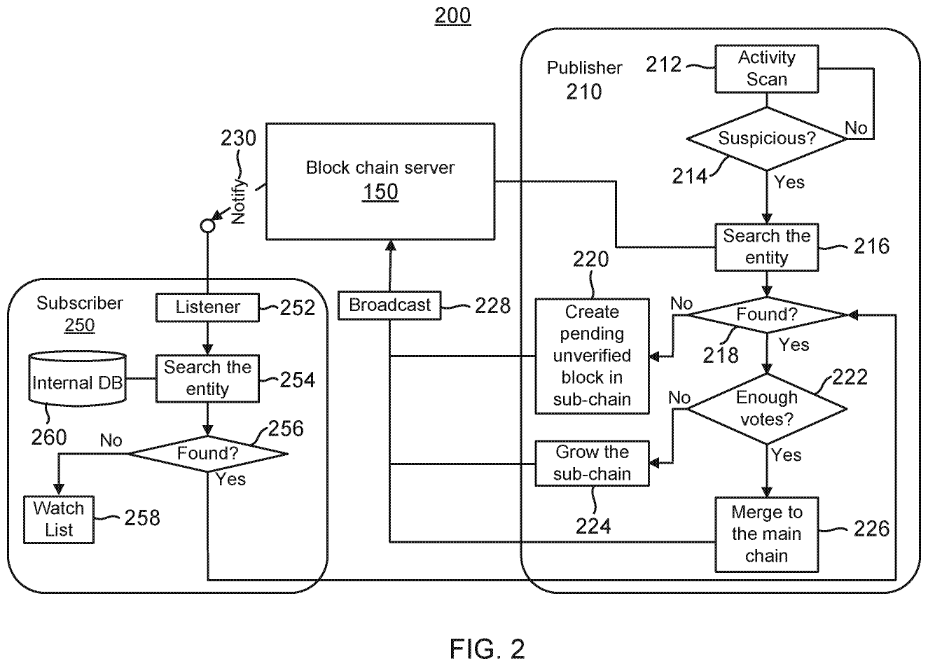

FIG. 2 is an illustration of an example process 200, all or portions of which may be performed by a publisher 210 and/or a subscriber 250 to detect, verify, and record suspicious activity according to one embodiment. An example of a publisher 210 may be any one of the members A-N of FIG. 1, and an example of a subscriber 250 may include any other one of the members A-N. The actions shown in FIG. 2 are understood to be actions that may be performed by the appropriate ones of the servers 110-140 of FIG. 1 according to various embodiments.

Actions 212 and 214 include determining whether suspicious activity is detected. For instance, actions 212 and 214 may include running a risk analysis algorithm on a current transaction to which the member (publisher 210) is a counterparty. Different members may have different risk analysis algorithms, and it is understood that some members may determine that a same transaction has a different risk profile than would other members (thus, the present disclosure supports the heterogenous sharing of risk algorithm assessments via a safe and secure platform). In any event, actions 212 and 214 may include comparing details of the transaction against a set of criteria. In one use case, an example suspicious transaction may include a sender of funds purchasing a large amount of goods (e.g., 100 toys) from a receiver of funds when that sender has no record of previous purchases similar to that purchase. A further transaction that might raise the suspicion level would be if the sender then initiates a refund of the purchase price and, especially, if the refund is for substantially less than the purchase price. Furthermore, if the refund request is made to a funding source different from the funding source used for the purchase, that may also increase the suspiciousness level. Another example use case includes when either the sender or the receiver is on a sanctions watchlist. The risk analysis algorithm of the publisher 210 may store a multitude of different criteria for different use cases, where the criteria define traits of suspicious transactions. Examples of suspicious transactions may include any transactions that appear to be potentially prohibited or illegal.

Accordingly, if actions 212 and 214 determine that the transaction is not suspicious, then publisher 210 continues to monitor subsequent transactions, according to various embodiments. However, if the risk analysis algorithms compare the transaction details against the criteria and determine that the transaction appears to be suspicious, then the process 200 moves to action 216, according to some embodiments.

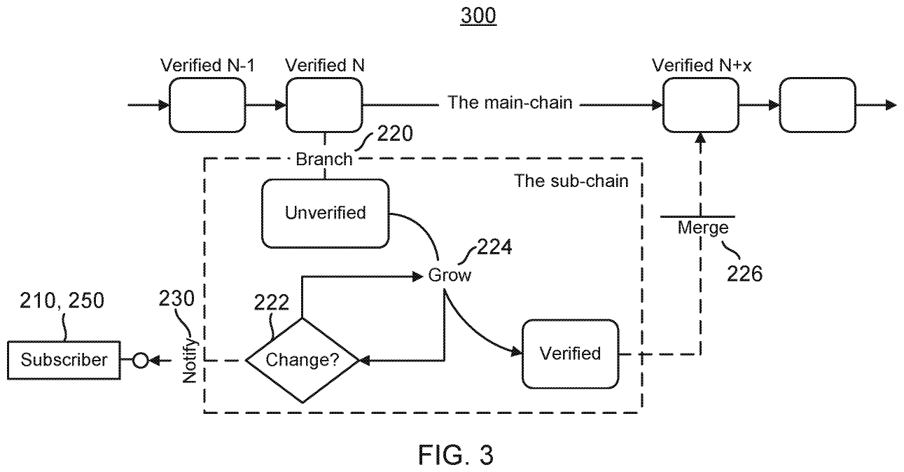

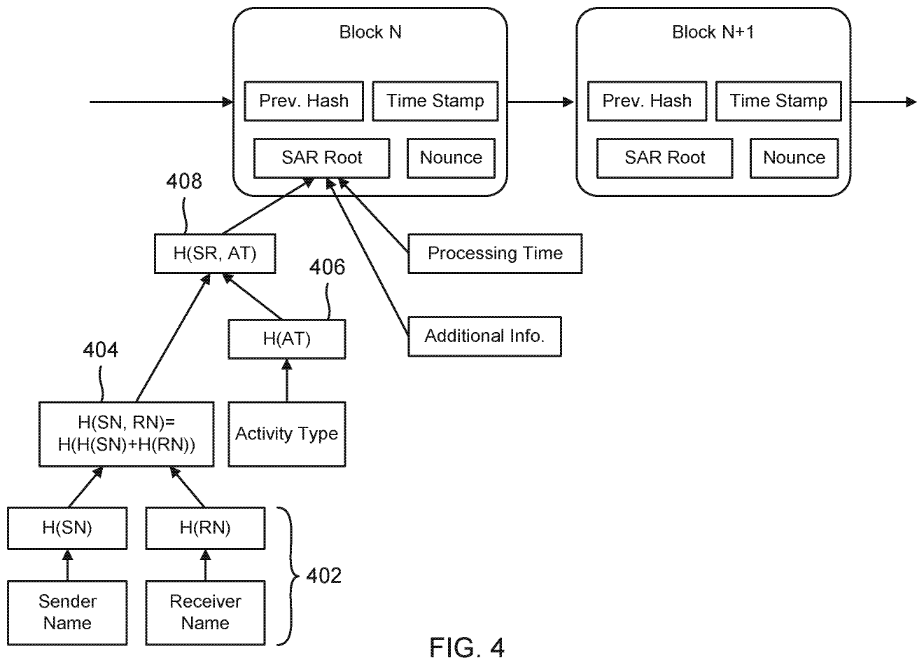

At action 216, the publisher 210 checks the blockchain server 150 to determine whether there is an existing sub chain for that same sender and receiver pair for the same or a related transaction. For instance, the publisher 210 may use a name of the sender or receiver as search criteria to search within the existing sets of sub chains at blockchain server 150. If no previous block is found, then the publisher 210 starts a sub chain by creating a new unverified block on top of the current head of the main chain for verification by other peers. Put another way, the publisher 210 creates an unverified sub chain as a branch to the main chain at action 220. The publisher may create blocks in the new sub chain that include the names of the sender and receiver pair, an identification of the transaction, an indication of activity type, a suspiciousness level, a time of the transaction, and any other information that may be useful. The publisher 210 starts the new sub chain at blockchain server 150, and an example main chain and sub chain are explained in more detail with respect to FIGS. 3 and 4.

However, if action 218 finds an unverified block regarding the same sender and receiver pair and a same or related transaction at blockchain server 150, the publisher 210 may then determine whether the transaction has enough votes to be verified as suspicious. If there are enough votes, including the vote of publisher 210, then the publisher creates a verified block as the new head of the sub chain and merges the sub chain back into the main chain at action 226. Merging the sub chain back into the main chain may include carrying over the verification history from the sub chain to the main chain. Merging the sub chain back into the main chain is described in more detail with respect to FIG. 3.

If there are not enough votes at action 222, then the publisher 210 may grow the sub chain by adding new unverified blocks to the sub chain at action 224, where those new unverified blocks would include details of the transaction to which the publisher 210 is a party, including the names of the sender and receiver pair, an identification of the transaction, an indication of activity type, a suspiciousness level, a time of the transaction, and any other information that may be useful. In other embodiments, votes may not be weighed equally between members or subscribers. For example, an established highly sophisticated or large counterparty may have its vote weighed more heavily than a less sophisticated or smaller counterparty, in which case the larger counterparty's vote may be weighted times more than the smaller counterparty's vote.

Actions 220 and 224 may further include causing the blockchain server 150 to broadcast 228 a notification (action 230) to other interested members. Actions 228 and 230 may be performed in any appropriate manner, such as sending an indication to subscriber 250 notifying the subscriber that a new sub chain has been started for a transaction to which subscriber 250 is known to be a counterparty. In another example, actions 228, 230 may include the publisher 210 sending a message that identifies one or more of the sender, the receiver, the transaction, or other information and perhaps in encrypted form. In the example of FIG. 2, the other interested member includes subscriber 250, although other embodiments may include additional interested parties, including any other counterparties to the particular transaction. Actions 228 and 230 may include sending messages to fewer than all the members, so that the subset of members receiving the message is limited to the known counterparties to the transaction and any other members who might have opted in for notification. In some embodiments, members can get notification on some transactions that they have subscribed to put on their internal watch-list without being actually involved directly in those transactions. In any event, various embodiments include sending the notification of actions 228, 230 to less than all of the members in order to avoid sending messages to un-interested parties, thereby reducing noise in the system.

Continuing with the example of FIG. 2, the subscriber 250 includes a listening module 252, which is in communication with network 160 and blockchain server 150. If a new detection is reported through a notification, then the subscriber 250 may search its internal database 260 at action 254 for the sender or receiver to verify the existence of the sender or receiver and to evaluate the suspiciousness level of the particular transaction according to its own risk analysis algorithms.

If action 256 does not find the sender or receiver or does not observe suspicious activity, then the subscriber 250 may add the new entity on its internal watchlist to scan future incoming transactions. If the sender or receiver is not found or there is no suspicious activity at action 256, the subscriber 250 may decline to verify the suspicious activity at blockchain server 150. Declining to verify the suspicious activity may include taking no further action or may include adding a block to the sub chain to indicate the result of the risk analysis algorithm.

However, if action 256 does find suspicious activity, then subscriber 250 may perform the actions of 218 and 222 by adding its own verification and then either growing the sub chain or merging the sub chain into the main chain (or triggering the publisher 210 to perform the merging).

Accordingly, the example of FIG. 2 shows two of the voting members (publisher 210 and subscriber 250) detecting suspicious activity, verifying suspicious activity, and interacting with the blockchain server 150 to record the transaction. Of course, as method 200 is being performed, other subscribers may be notified and may also interact with the blockchain in a same or similar manner as subscriber 250 interacts with the blockchain. The blockchain may continue to grow until the threshold number of verification votes are added to the sub chain, at which point the sub chain may be merged into the main chain.

FIG. 3 is an illustration of an example process 300 for creating a sub chain and then merging that sub chain into a main chain, according to one embodiment. The actions of process 300 may be performed by the subscribers 210, 250 as they interact with the blockchain server 150. The blockchain server 150 may include an application that grows and maintains the blockchain as well as stores the blockchain securely.

The main chain is shown including a plurality of blocks that are verified, which means that those blocks represent transactions that have been indicated as suspicious and then verified as suspicious by at least a threshold number of interested parties, as explained above, according to various embodiments. Method 300 includes an indication of subscribers 210, 250, though the scope of embodiments may include any appropriate number of members who may be notified at action 230 and then vote on the transaction.

At one particular time, the block labeled “Verified N” is a current last block in the main chain. At that time, the publisher 250 performs action 220, thereby creating the sub chain as an unverified branch from the main chain. For instance, the first block in the sub chain may include a hash based on the “Verified N” block, thereby linking that first block of the sub chain to the current last block of the main chain. As the sub chain is created, the various members may be notified and either verify the suspicious nature of the transaction or decline to verify the suspicious nature of the transaction. At actions 222 and 224, the sub chain may continue to grow as more members add their own blocks to the sub chain and vote on the sub chain. In one example, each of the added sub chain blocks may include an indication of a verification vote by its respective member.

Furthermore, the subscribers may grow the sub chain as the sender and receiver engage in additional transactions during the life of the sub chain. For instance, if the sender and receiver perform a first transaction that appears to be suspicious, then the subscribers may generate one or more blocks describing that first transaction. When the sender and receiver perform a second transaction that also appears to be suspicious, then additional blocks may be added to update the sub chain, including information in the blocks identifying that subsequent transaction and the sender and receiver.

FIG. 3 illustrates an example in which enough members vote to verify the transaction as suspicious, and the publisher 250 then merges the sub chain back into the main chain. In some examples, the main chain will have grown during the time that the sub chain was being created and maintained so that the sub chain is merged into a later block, illustrated in this example as “Verified N+X”. Merging the sub chain into the main chain in this example would include the publisher 210 creating a new verified block as the head of the sub chain, where the verified block includes a hash of the immediately previous block in the sub chain as well as a hash of the immediately previous block of the main chain (the block immediately before Verified N+X). In this way, the integrity of the sub chain and the main chain is preserved, and the verification history in the sub chain is also preserved as a part of the main chain.

FIG. 4 is an illustration of example blocks that may be used in both the sub chain and the main chain in FIG. 3 according to one embodiment. The blocks of FIG. 4 conform to a Merkle tree, though the scope of embodiments may include any appropriate blockchain configuration, whether as a Merkle tree or otherwise.

FIG. 4 shows two blocks (Block N and Block N+1), and it is understood that the blockchain may have blocks preceding Block N and blocks subsequent to Block N+1. Each of Block N and Block N+1 are constructed similarly, so that description of Block N is understood to be exemplary of the other blocks in the chain. Block N includes four parts that are shown—previous hash, timestamp, root, and nonce. Previous hash is a hash constructed using the contents of the block immediately preceding Block N, thereby establishing a relationship between those two blocks and preventing the immediately preceding block from being changed at a later time. The timestamp may include a timestamp of the transaction that is the subject of the particular block, as that transaction is observed by a particular member. For instance, if a payment service provider facilitates a purchase at a merchant, then the payment service provider may include the time that is contacted by the merchant POS as the timestamp. Furthermore, the timestamp may conform to any particular level of detail, whether by day, hour, second, or finer or coarser. In this example, the timestamp is included in Block N in an unencrypted form, thereby allowing any member to search by timestamp without decrypting hashes. Also, some financial transactions may take multiple days to advance from one financial institution to another, such as when a payment card service provider debits an issuing bank, the issuing bank may not get debited until weeks later. Accordingly, the timestamp may serve for coarse searching rather than precise searching in some instances.

The nonce may include a pseudorandom number used as a signature for Block N. The pseudorandom number may be generated by a central authority at the blockchain server 150 or by one of the members. In some instances, the pseudorandom number may be generated by the member acting as publisher 210. One difference between conventional blockchains and various embodiments is that some blockchains rely on a race between entities to assign a nonce to an entity that is first to solve a mathematical puzzle. However, various embodiments of the present disclosure do not incentivize members for being first, instead assigning the nonce to any appropriate member as that member creates a block of the sub chain.

The root of Block N (“SAR Root”) includes a multitude of different pieces of information. At action 402, each of the sender name and receiver name are hashed separately. An example of a hash algorithm that may be used for any of the hashing actions to create the blocks includes MD5, though any appropriate hashing algorithm may be used in various embodiments. At action 404, a mathematical function is performed to add the hashes from action 402 and then to perform an additional hashing action. At action 406, an activity type indication is also hashed. An example of an activity type may include an identifier for a type of transaction, such as purchase of goods, money transfer, refund, and the like. At action 408, the activity type hash (from action 406) and the hash resulting from action 404 are hashed together.

The root includes other types of information that are not hashed and thus provide a non-hashed searching resource for interested members who may desire to search either a sub chain or a main chain. For instance, the root may further include processing time, which may include a timestamp added by a member who generates the particular block. Furthermore, the root may include “additional information,” which may include any of a variety of transaction notes that may be beneficial for searching. Examples of additional information may include identification of counterparties, an indication of whether a counterparty verified the suspicious activity, an indication of a suspiciousness level identified by a risk algorithm of a counterparty, and the like. In other embodiments, the additional information may be hashed if it includes sensitive information that is prohibited from being shared without encryption, such as personal identifying information.

A party searching the main chain and sub chain may search against any of the items in the blocks. As noted above, some of the items are not hashed and therefore may be searched without decryption. On the other hand, other items are hashed and may either be searched by beginning with a hashed value and searching for that hashed value or beginning with an unencrypted value and then decrypting hashed values in the blocks to find a match. In some examples, searching may include a member using a Merkle tree root and other conditions as search criteria, and the blockchain server uses that criteria to search through the main chain plus unmerged sub chains to cover the on-going cases.

As noted above, a sub chain may branch from a main chain. In an example in which Block N is a first block in a sub chain, the previous hash may include a hash generated from the most recent verified block. The next block in the sub chain (Block N+1) may include a hash generated from Block N. When merging back into the main chain, the verified block would be generated using a hash from both the most recent block in the sub chain and a hash from the most recent block in the main chain.

In payment networks, a transaction record may contain a variety of information including sender/receiver name, transaction amount, activity type, processing time and identifiers assigned by different institutions. Various embodiments may include any of this information in the blocks of the sub chain or the main chain. Some items of information, such as names and dollar amounts may be universal for uniquely identifying the transaction among financial institutions, whereas some other pieces of the information might be different among institutions even if it is regarding the same transaction. For example, the transaction date may have small lags depending on the latency and time resolution used by different institutions, the activity type and id-formats may be defined differently in each institution. Furthermore, the suspiciousness level may be assessed differently at each institution, depending on the timing and the institution's internal criteria in its risk analysis algorithms.

Also, some information like addresses and phone numbers can be personal identifying information, which may be restricted to be exchanged without encryption and are thus hashed in this example.

To efficiently exchange the transaction record data relating to suspicious activities in a secure and efficient way, some mechanisms may be adopted to handle each type of information. For instance, the various members of the system may agree to normalize their information before submitting the information to the system. For instance, the various members may agree on specific ways of expressing activity type, suspiciousness level, and any other transaction characteristic so that the various members input normalized information to the system. This may enhance the ability to search as well as to understand and analyze information generated by another member. Members may also agree on content for the additional information block, both its content and format, thereby allowing members to efficiently search the additional information.

Additionally, some embodiments may normalize the techniques used to combine and hash data, thereby ensuring that hashed data can be understood by other members. Moreover, some embodiments may include the members expressing the transaction date in timestamp format, thereby allowing other members to search coarsely around a range of times when more finely grained timestamps may not be useful. Also, the additional information (such as transaction notes) can be added in plain format or hashed, depending on how the members may agree.

Various embodiments may implement the system as a private block chain. For instance, in the system of FIG. 1, the block chain server 150 may include security features, such as logins/passwords, encryption, and the like to allow access for the members 110-140 while excluding non-members, such as senders and receivers. Also, the block chain server 150 may track memberships and maintain memberships using tracking records to identify members as they attempt to access the block chain. Such feature may be advantageous in that it may prevent malicious actors from interfering with the block chain or from observing the members 110-140 reporting suspicious activities.

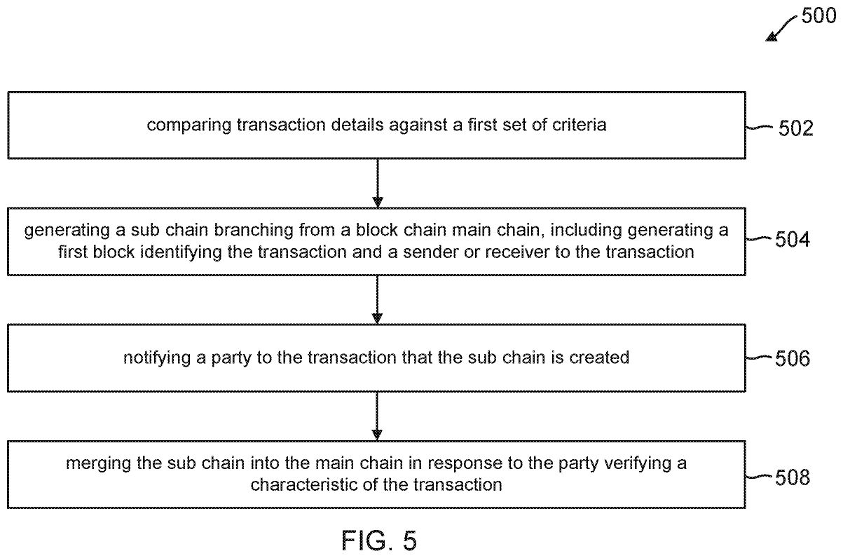

FIG. 5 is an illustration of example method 500 for detecting a suspicious transaction, according to one embodiment. Method 500 may be performed by server (e.g., any of servers 110-140) as they interact with blockchain server 150, specifically, by a processor of a server as it executes computer code to provide functionality described herein.

At action 502, a server compares transaction details against a first set of criteria. In one example, the first set of criteria may be indicative of activity that is illicit, fraudulent, or otherwise prohibited. In one example, the set of criteria comprises prohibited (or otherwise suspicious) activity detection criteria. For instance, action 502 may include a financial institution analyzing the transaction according to its risk algorithms. In some instances, the risk algorithm may indicate that the transaction has a low level of risk, whereas in some instances the risk algorithm may indicate that the transaction has a higher level of risk. The financial institution may use any appropriate risk level and any set of criteria, as appropriate, at action 502. Furthermore, transaction may be between a sender and a receiver, who may be end-users (e.g., a consumer and a merchant or to consumers) and different from the financial institution counterparties that are members of the detection system.

Action 504 may include the server generating a sub chain branching from a blockchain main chain in response to the comparing that was performed at action 502. For instance, at action 502 if the financial institution determines that the suspiciousness level of the transaction, as it compares with the first set of criteria, justifies marking the transaction as potentially suspicious, then the financial institution may generate the sub chain. As noted above, the sub chain block may branch from a main chain, and it may include a variety of different information, such as a name of the sender, a name of the receiver, activity type, a processing time, and additional information (e.g., identification of financial institution counterparties, identification of suspiciousness level, etc.).

At action 506, the server notifies a party to the transaction that the sub chain is created. For instance, the party that performs actions 502 and 504 may understand from the nature of the transaction that one or more counterparties may be involved in the transaction. For instance, a payment card service provider may know of an issuing bank because of its relationship with the issuing bank and it may know of an acquiring bank because the transaction would have indicated that the funds from the transaction should be transferred to the acquiring bank. Accordingly, if the payment card service provider performs actions 502 and 504, it may also reach out to the issuing bank and acquiring bank at action 506 because the issuing bank and the acquiring bank are also directly involved in the transaction.

Furthermore, if there are other parties (members of the system) that may not be directly involved in the transaction but may have otherwise requested to subscribe to some notifications, then action 506 may include providing a notification to those parties. In any event, action 506 may include notifying less than all of the members of the system.

The notified party may take appropriate action in response to the notification. For instance, the notified party may search its own internal database for mention of the sender or receiver and may add the sender or receiver to a watch list if appropriate.

At action 508, the server merges the sub chain into the main chain in response to the party verifying a characteristic of the transaction. As noted above, the system may set thresholds for a number or total weighted vote of parties to verify that a transaction is suspicious before the sub chain may be merged into the main chain as a verified suspicious transaction. Various embodiments may accommodate any appropriate number of parties to verify the characteristic of the transaction (e.g., vote on the transaction). In this example, the notified party may investigate the transaction using its own risk analysis algorithms to verify a characteristic (e.g., similarity to a prohibited or otherwise suspicious activity) of the transaction and verifying that the transaction has at least one trait of a suspicious transaction. Verifying the characteristic of the transaction may include adding a block to the sub chain to identify the notified party and indicate that the notified party verified the characteristic of the transaction. Once the notified party has verified the characteristic of the transaction, and if that reaches the requisite threshold (e.g., number of votes or total weighted vote), then the server may then merge the sub chain into the main chain, as described above with respect to FIG. 3. Merging the sub chain into the main chain includes recording verification history of the sub chain into the main chain so that it may be searched or confirmed at a later time.

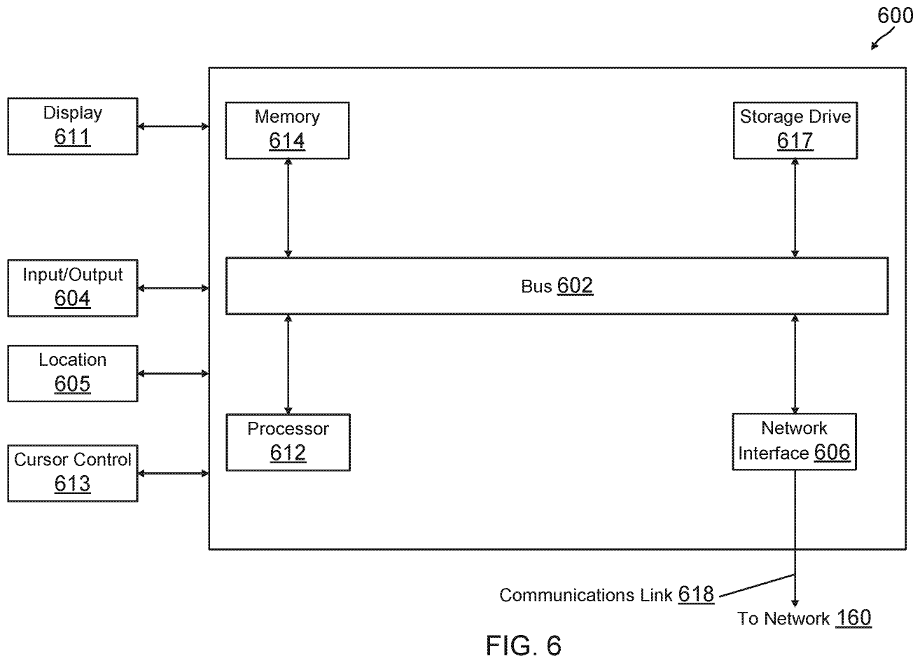

The scope of embodiments is not limited to the particular series of actions depicted in FIG. 6. Rather, various embodiments may add, omit, rearrange, or modify the actions. For instance, various embodiments may include taking action in response to the notification of suspicious activity. For instance, some counterparties may decline the transaction in response to their own internal risk algorithms, in response to the notification from another party, in response to the sub chain being verified by the appropriate number of votes, or other criteria. Furthermore, subsequent transactions by the same sender and receiver may occur as the blockchain is being generated. In that event, the server may compare the subsequent transaction to the first transaction and determine that the sender and receiver are the same for both transactions and then update the sub chain by generating another block identifying that subsequent transaction.

Various embodiments may encompass use cases across a variety of industries. For instance, some industries may include techniques to specifically identify assets (e.g., gemstones or luxury properties) and then include those asset identifiers in the blockchain each time an asset is transferred. In such an instance, action 502 may include comparing an identifier of a first item being purchased in the transaction to an identifier of a second item in a prior transaction in the main chain, determining that the first item is the same as the second item, and then taking an appropriate action. For instance, if the first item has been reported as stolen or has been replaced by insurance, that may be an indicator of a suspicious transaction.

Various embodiments may also be used to prevent insurance abuse. For instance, each time an insurance claim is made, an insurance company that is a member of the system may create a new sub chain or add to an existing sub chain of a same claimant to describe the claim. Over time, if a same claimant makes suspicious claims to its insurance company, the blockchain may reflect this potential issue. Furthermore, since other insurance companies may be members they may observe the chain. Accordingly, when a claimant suspected of insurance abuse makes an additional claim or attempts to open a new policy with the same or different insurance company, the involved insurance company may search the chain for the claimant and decline the purchase of insurance or decline a claim in response to searching the chain. Furthermore, the chain may keep track of individuals other than the claimant (e.g., accident witnesses, other parties involved) and potentially identify a third party who worked with a claimant to commit insurance abuse.

FIG. 6, an embodiment of a computer system 600 suitable for implementing, for example, the computing devices 102, 104, and 110-150 of FIG. 1 discussed above. It should be appreciated that other devices utilized in the system discussed above may be implemented as the computer system 600 in a manner as follows.

In accordance with various embodiments of the present disclosure, computer system 600, such as a smart phone, computer, and/or a network server, includes a bus 602 or other communication mechanism for communicating information, which interconnects subsystems and components, such as a processing component 612 (e.g., processor, micro-controller, digital signal processor (DSP), etc.), a system memory component 614 (e.g., RAM) a storage drive component 617 (e.g., solid-state, hard drive, or optical), a network interface component 606 (e.g., wireless card, modem, or Ethernet card), a display component 611 (e.g., a touchscreen, CRT, or LCD), an input/output component 604 (e.g., keyboard, keypad, a touchscreen), a cursor control component 613 (e.g., mouse, pointer, or trackball), and/or a location determination component 605 (e.g., a Global Positioning System (GPS) device as illustrated, a cell tower triangulation device, and/or a variety of other location determination devices known in the art). In one implementation, the storage drive component 617 may comprise a database having one or more storage drive components.

In accordance with embodiments of the present disclosure, the computer system 600 performs specific operations by the processor 612 executing one or more sequences of instructions contained in the memory component 614, such as described herein with respect to FIGS. 1-5 discussed above. Such instructions may be read into the system memory component 614 from another computer readable medium, such as storage drive 617. In other embodiments, hard-wired circuitry may be used in place of or in combination with software instructions to implement the present disclosure.

Logic may be encoded in a computer readable medium, which may refer to any tangible and non-transitory medium that participates in providing instructions to the processor 612 for execution. Such a medium may take many forms, including but not limited to, non-volatile media and volatile media. In various implementations, non-volatile media includes hard drive or solid-state drives, such as the storage drive component 617, and volatile media includes dynamic memory, such as the system memory component 614. Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 600. In various other embodiments of the present disclosure, a plurality of the computer systems 600 coupled by a communication link 618 to the network 160 (e.g., such as a LAN, WLAN, PTSN, and/or various other wired or wireless networks, including telecommunications, mobile, and cellular phone networks) may perform instruction sequences to practice the present disclosure in coordination with one another.

The computer system 600 may transmit and receive messages, data, information and instructions, including one or more programs (i.e., application code) through the communication link 618 and the network interface component 606. The network interface component 606 may include an antenna, either separate or integrated, to enable transmission and reception via the communication link 618. Received program code may be executed by processor 612 as received and/or stored in storage drive component 617 or some other non-volatile storage component for execution.

The present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure.

Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
performing the following actions by one or more network servers:
receiving a transaction comprising data associated with the transaction;
comparing details of the transaction against a set of criteria;
generating a sub chain branching from a blockchain main chain based on the comparing, including generating a first block in the sub chain identifying the transaction and a sender or receiver for the transaction;
notifying one or more parties to the transaction about the sub chain;
determining that a threshold number of the one or more parties have verified a characteristic of the transaction; and
merging the sub chain into the main chain based on the verifying.

2. The method of claim 1, wherein the set of criteria comprises suspicious activity detection criteria, and wherein a first party of the one or more parties verifying the characteristic includes the first party verifying that the transaction has at least one trait of a suspicious transaction.

3. The method of claim 1, wherein generating the first block comprises:
hashing a sender name, a receiver name, and an activity type corresponding to the transaction to create hashed content; and
adding the hashed content to a timestamp associated with the transaction in the first block.

4. The method of claim 3, wherein the hashed content is included in a root portion of a Merkle tree block.

5. The method of claim 1, further comprising:
in response to receiving a subsequent transaction, comparing the subsequent transaction to the transaction and determining that the sender is a same sender for both the transaction and the subsequent transaction; and
updating the sub chain, including generating a second block identifying the subsequent transaction with the sender.

6. The method of claim 1, wherein notifying the one or more parties to the transaction comprises:
within a membership of the blockchain, notifying the one or more parties and other parties involved in the transaction and omitting notifying members of the blockchain not involved in the transaction.

7. The method of claim 1, wherein notifying the one or more parties to the transaction comprises:
within a membership of the blockchain, omitting notifying members of the blockchain not involved in the transaction that have not opted to receive a notification.

8. The method of claim 1, wherein merging the sub chain into the main chain comprises adding a nonce in a head block of the sub chain and adding the sub chain to the main chain; and wherein the method further comprises:
recording verification history of the sub chain in the main chain.

9. The method of claim 1, wherein the transaction comprises a first credit card transaction for a purchase of merchandise and a second credit card transaction for a return of the merchandise, further wherein comparing the details of the transaction against the set of criteria comprises:
determining that the first credit card transaction and the second credit card transaction fit a pattern of returning purchased merchandise for a smaller amount of money than for purchasing the merchandise; and
marking the transaction as suspicious in the sub chain.

10. The method of claim 1, wherein comparing the details of the transaction against the set of criteria comprises:
comparing an identifier of a first item being purchased in the transaction to an identifier of a second item identified as stolen in the main chain; and
determining that the first item is the same as the second item;
further wherein the method comprises declining the transaction.

11. The method of claim 1, wherein the transaction comprises a credit or debit card transaction, and further wherein the one or more parties to the transaction include an issuing bank and an acquiring bank.

12. The method of claim 11, wherein a party associated with comparing the details of the transaction against the set of criteria includes a payment service separate from the issuing bank and the acquiring bank.

13. The method of claim 1, wherein the transaction comprises a purchase of insurance, further wherein comparing the details of the transaction against the set of criteria comprises:
determining that a purchaser of the insurance is associated with prior suspicious insurance claims; and
marking the transaction as suspicious;
wherein the method further comprises declining the purchase of insurance.

14. A non-transitory machine-readable medium having stored thereon machine-readable instructions executable to cause a machine to perform operations comprising:
comparing details of a transaction against a set of criteria;
in response to comparing the details of the transaction against the set of criteria, creating a sub chain branching from a blockchain main chain, including generating a first block identifying the transaction and a sender and receiver pair of the transaction;
notifying a party to the transaction about the sub chain;
determining that the party has voted the transaction as suspicious; and
merging the sub chain into the main chain based on the party voting.

15. The non-transitory machine-readable medium of claim 14, wherein the operations further comprise:
in response to a subsequent transaction, comparing the subsequent transaction to the transaction and determining that the sender and receiver pair is a same sender and receiver pair for both the transaction and the subsequent transaction; and
updating the sub chain, including generating a second block identifying the subsequent transaction with the sender and receiver pair.

16. The non-transitory machine-readable medium of claim 14, wherein the transaction comprises a first credit card transaction for a purchase of merchandise and a second credit card transaction for a return of the merchandise, further wherein comparing the details of the transaction against the set of criteria comprises:
determining that the first credit card transaction and the second credit card transaction fit a pattern of returning purchased merchandise for a smaller amount of money than for purchasing the merchandise; and
marking the transaction as suspicious in the sub chain.

17. The non-transitory machine-readable medium of claim 14, wherein comparing the details of the transaction against the set of criteria comprises:
comparing an identifier of a first item being purchased in the transaction to an identifier of a second item in a prior transaction in the main chain; and
determining that the first item is the same as the second item;
further wherein the operations comprise declining the transaction.

18. A system, comprising:
a non-transitory memory; and
one or more hardware processors coupled to the non-transitory memory and configured to read instructions from the non-transitory memory to cause the system to perform operations comprising:
creating a sub chain branching from a blockchain main chain in response to analyzing a transaction for risk, including identifying a sender and receiver pair in a first block of the sub chain;
notifying a plurality of parties to the transaction that the transaction is suspicious;
receiving input associated with transaction from at least a subset of the plurality of parties; and
merging the sub chain into the main chain based on the input meeting a threshold indicating that the transaction is suspicious.

19. The system of claim 18, wherein the transaction comprises a first credit card transaction for a purchase of merchandise and a second credit card transaction for a return of the merchandise, further wherein analyzing the transaction for risk comprises:
determining that the first credit card transaction and the second credit card transaction fit a pattern of returning purchased merchandise for a smaller amount of money than for purchasing the merchandise; and
marking the transaction as suspicious in the sub chain.

20. The system of claim 18, wherein the transaction comprises a credit card transaction, and further wherein the one or more parties to the transaction include an issuing bank and an acquiring bank, and wherein a party that analyzes the transaction for risk includes a payment service separate from the issuing bank and the acquiring bank.
